(19) United States
(12) Patent Application Publication
(10) Pub. No.: US 2026/0328371 A1
(43) Pub. Date: Oct. 22, 2026

(54) LIGHT-EMITTING PRODUCT

(71) Applicant: Powerbeauty (Dongguan) Industrial Co., Ltd., Dongguan (CN)

(72) Inventor: Yiqun Xu, Dongguan (CN)

(21) Appl. No.: 19/691,509

(22) Filed: May 28, 2026

(30) Foreign Application Priority Data
Jul. 22, 2025 (CN) 202521540088.6

(51) Int. Cl. F21V 17/00; F21S 6/00; F21V 15/015; F21V 17/10; F21V 17/12

(52) U.S. Cl. CPC F21V 17/007; F21S 6/004; F21V 15/015; F21V 17/104; F21V 17/12

(57) ABSTRACT

A light-emitting product includes a light core, a top cover, and a plurality of upright strips spaced apart from each other and collectively arranged to form a ring-like structure. The top cover is provided with a central through-hole and a plurality of upper embedding spaces spaced apart from each other and arranged around the central through-hole. Upper ends of the upright strips are fitted into the upper embedding spaces. The light core is inserted through the central through-hole, and the top cover further supports the light core from below. The product is easy for users to assemble manually and convenient for packaging, storage, and transport.

### CROSS REFERENCE TO RELATED APPLICATIONS

The present application claims the benefit of Chinese Patent Application No. 202521540088.6 filed on Jul. 22, 2025, the contents of which are incorporated herein by reference in their entirety.

### FIELD OF THE INVENTION

The present disclosure relates to a simulated-shaped lighting device, and more particularly to a light-emitting product made of materials such as simulated bamboo, bamboo, simulated wood, wood, simulated rattan, iron, or aluminum. The product may be, for example but not limited to, a lighting fixture or a side table.

### BACKGROUND OF THE INVENTION

With continuous economic development and social progress, people are provided with an increasingly diverse range of material consumer goods. Lighting fixtures are one such type of consumer goods.

Among the columnar lighting fixtures or illuminated cylindrical side tables made of simulated bamboo, bamboo, simulated wood, wood, simulated rattan, or similar materials that are currently available on the market, they are typically sold as pre-assembled finished products. Consequently, they require demanding packaging, occupy a large amount of space, are inconvenient to store and transport, and fail to meet users'desire for hands-on assembly.

Therefore, there is a need for a light-emitting product that overcomes one or more of the above-mentioned drawbacks.

### SUMMARY OF THE INVENTION

The present disclosure aims to provide a light-emitting product that is easy for users to assemble manually and convenient for packaging, storage, and transport.

To achieve the above objective, the present disclosure provides a light-emitting product including a light core, a top cover, and a plurality of upright strips spaced apart from each other and collectively arranged to form a ring-like structure. The top cover is provided with a central through-hole and a plurality of upper embedding spaces spaced apart from each other and arranged around the central through-hole. Upper ends of the upright strips are fitted into the upper embedding spaces. The light core is inserted through the central through-hole, and the top cover further supports the light core from below.

Compared to the prior art, the top cover is provided with the central through-hole and the plurality of upper embedding spaces that are spaced apart and arranged around the central through-hole. The upper ends of the upright strips are fitted into the upper embedding spaces, the light core is inserted into the central through-hole, and the top cover supports the light core from below. This configuration, on one hand, allows users to easily assemble the light-emitting product by hand without the need for any tools, and on the other hand, because the light-emitting product can be packaged in a disassembled state, it offers the advantages of convenient storage and transport.

### BRIEF DESCRIPTION OF THE DRAWINGS

FIG. 1 is a perspective view of a light-emitting product according to a first embodiment of the present disclosure.

FIG. 2 is an exploded perspective view of the light-emitting product shown in FIG. 1.

FIG. 3 is a further exploded perspective view of FIG. 2.

FIG. 4 is another perspective view of the further exploded view of FIG. 3 from a different angle.

FIG. 5 is a plan view of the top cover of the light-emitting product according to the first embodiment.

FIG. 6 is a plan view of the bottom cover of the light-emitting product according to the first embodiment.

FIG. 7 is a plan view of an upright strip of the light-emitting product according to the first embodiment.

FIG. 8 is a perspective view of a light-emitting product according to a second embodiment.

FIG. 9 is a plan view of the top cover of the light-emitting product according to the second embodiment.

FIG. 10 is a plan view of the bottom cover of the light-emitting product according to the second embodiment.

FIG. 11 is a perspective view of a light-emitting product according to a third embodiment.

FIG. 12 is an exploded perspective view of the light-emitting product shown in FIG. 11.

FIG. 13 is a perspective view of the top cover of the light-emitting product shown in FIG. 11.

FIG. 14 is a plan view of an upright strip of the light-emitting product shown in FIG. 11.

FIG. 15 is a perspective view of a light-emitting product according to a fourth embodiment.

FIG. 16 is an exploded perspective view of the light-emitting product shown in FIG. 15.

FIG. 17 is a perspective view of a light-emitting product according to a fifth embodiment.

FIG. 18 is an exploded perspective view of the light-emitting product shown in FIG. 17.

FIG. 19 is another exploded perspective view of FIG. 18 from a different angle.

FIG. 20 is a perspective view of a light-emitting product according to a sixth embodiment.

FIG. 21 is an exploded perspective view of the light-emitting product shown in FIG. 20.

### DETAILED DESCRIPTION OF ILLUSTRATED EMBODIMENTS

To provide a detailed explanation of the technical content and structural features of the present disclosure, the following is a detailed description in conjunction with the embodiments and the drawings.

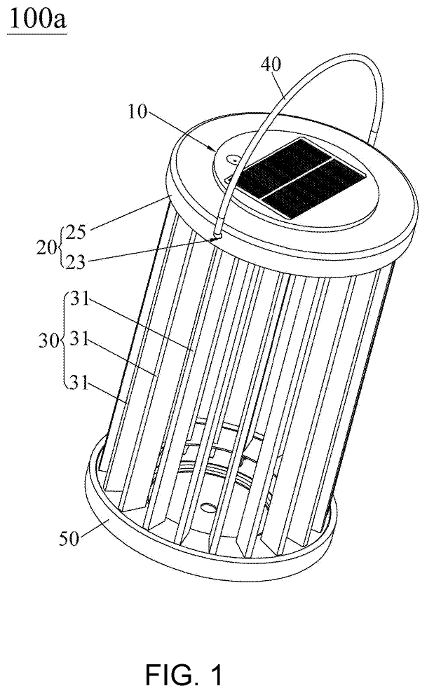

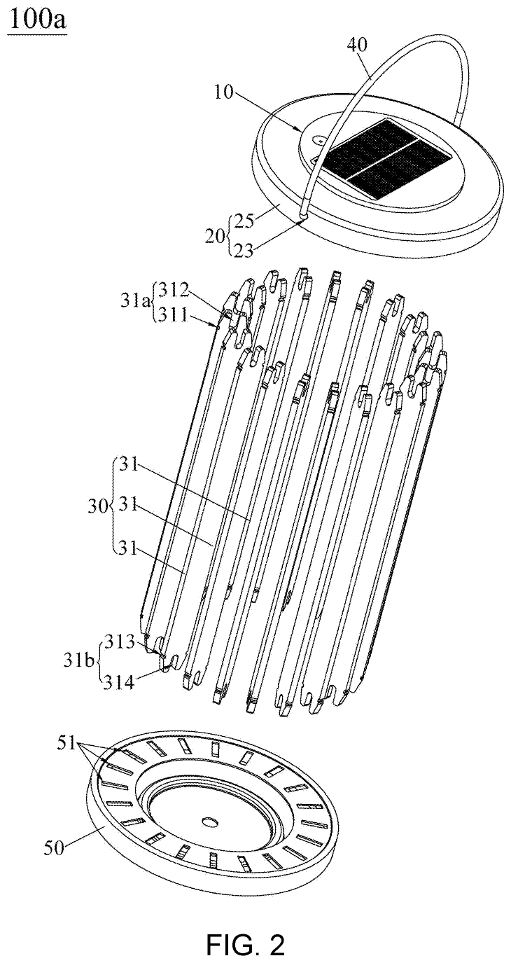

Referring to FIGS. 1 to 4, a light-emitting product 100a according to a first embodiment includes a light core 10, a top cover 20, and twenty upright strips 31 that are spaced apart from each other and collectively arranged to form a ring-like structure 30. Obviously, the number of upright strips 31 may vary depending on the desired density of the resulting ring-like structure 30. Moreover, the upright strips 31 can be made of materials such as bamboo, simulated bamboo, wood, simulated wood, simulated rattan, iron, or aluminum. It should be noted that, the term “light core” as used herein refers to a lighting component configured to emit light and be supported by the top cover.

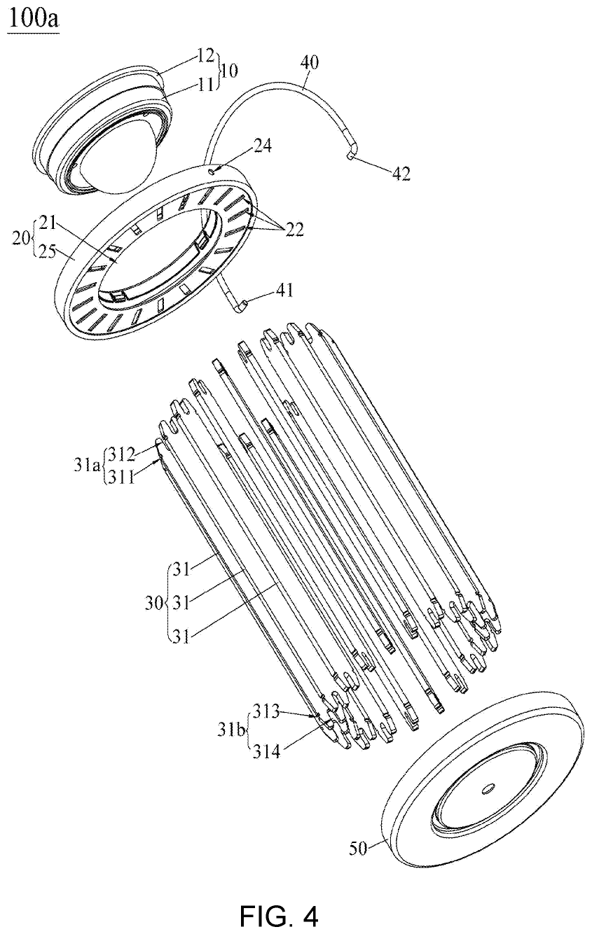

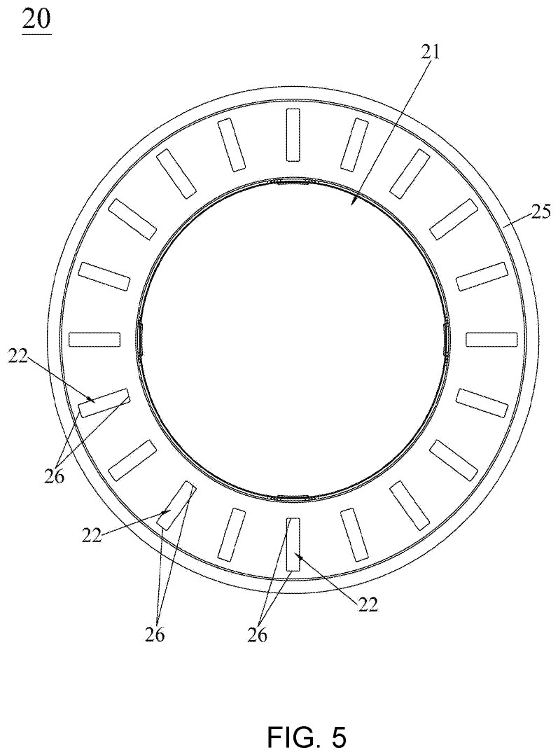

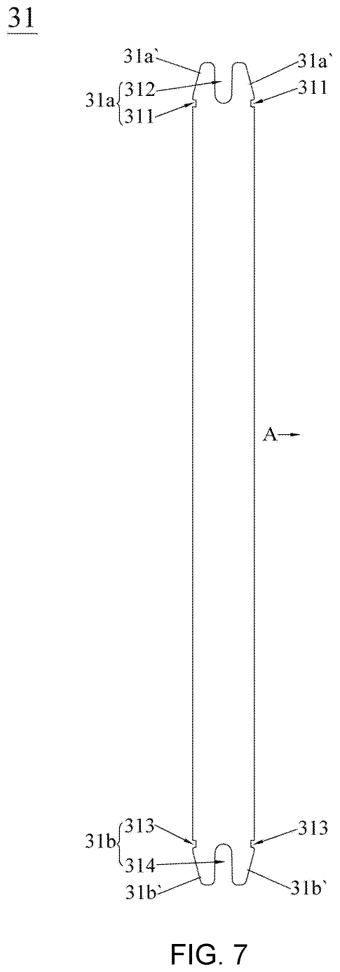

The top cover 20 is provided with a central through-hole 21 and a plurality of upper embedding spaces 22 that are spaced apart from each other and arranged around the central through-hole 21. The upper ends 31a of the upright strips 31 are fitted into the upper embedding spaces 22. As shown in FIGS. 4 and 5, in one example, the number of upper embedding spaces 22 equals the number of upright strips 31 so that one upper embedding space 22 accommodates the upper end 31a of one upright strip 31. However, the number of upper embedding spaces 22 may also be greater than the number of upright strips 31. The light core 10 is inserted into the central through-hole 21, and the light core 10 is also supported from below by the top cover 20, thereby stabilizing the light core 10. Specifically, in FIGS. 4 and 5, as an example, the upper embedding spaces 22 extend radially relative to the ring-like structure 30. Thus, when the upper ends 31a of the upright strips 31 are fitted into the upper embedding spaces 22, the upright strips 31 also extend radially, giving the ring-like structure 30 a radiating effect. Additionally, as shown in FIG. 5, the upper embedding spaces 22 are adjacent to the peripheral edge 25 of the top cover 20. The upper ends 31a of the upright strips 31 are inserted upward into the upper embedding spaces 22. As shown in FIG. 7, each upper end 31a is provided on at least one of its two sides 31a′ spaced apart in the width direction (indicated by arrow A and its opposite direction in FIG. 7) with an engaging groove 311. The engaging groove 311 engages with a portion 26 of the top cover 20 that defines the corresponding upper embedding space 22, thereby improving the ease of assembly between the upper ends 31a of the upright strips 31 and the top cover 20.

It should be noted that although FIG. 7 shows engaging grooves 311 on both sides 31a′ of the upper end 31a of each upright strip 31, it is also possible to provide an engaging groove 311 on only one of the two sides 31a′ depending on actual needs, and the present disclosure is not limited to the configuration shown in FIG. 7. More details are provided below.

As shown in FIG. 7, the upper end 31a of the upright strip 31 is further provided with an upwardly extending upper separating slot 312. The two sides 31a′ of the upper end 31a are tapered upward in the width direction. The upper separating slot 312 provides resilience to the two sides 31a′ of the upper end 31a. The upwardly tapering configuration facilitates insertion of the upper end 31a into the corresponding upper embedding space 22. Moreover, the resilience allows the two sides 31a′ to more easily pass over the portion 26 of the top cover 20 defining the upper embedding space 22, thereby ensuring smooth engagement of the engaging groove 311 with the portion 26.

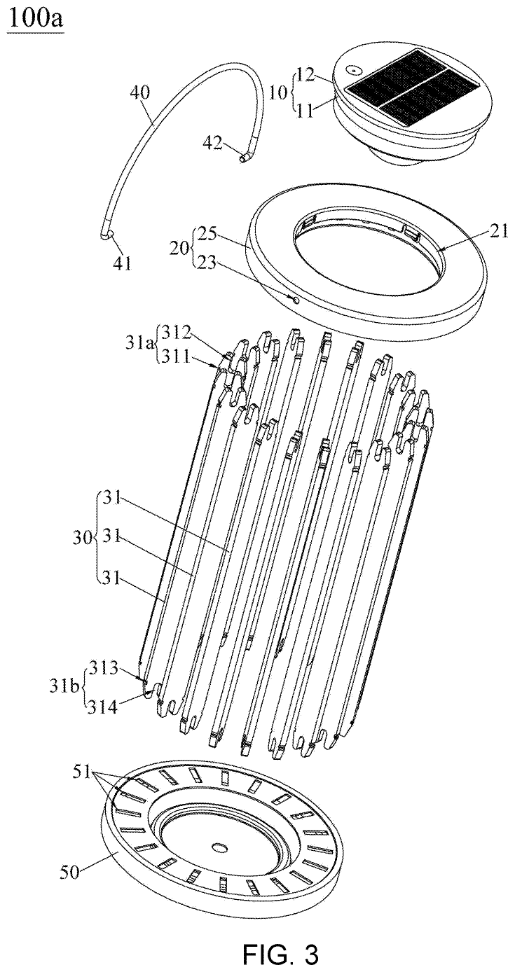

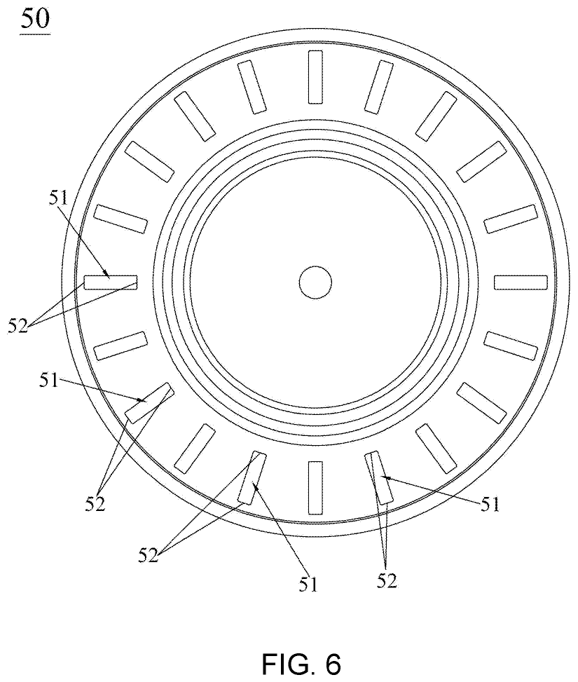

As shown in FIGS. 1 to 4, in one example, the light-emitting product 100a of the first embodiment further includes a handle 40 and a bottom cover 50. As shown in FIG. 6, the bottom cover 50 is provided with a plurality of lower embedding spaces 51 spaced apart from each other and arranged in a ring-like configuration. The lower ends 31b of the upright strips 31 are fitted into the lower embedding spaces 51. As shown in FIG. 7, each lower end 31b is provided on each of its two sides 31b′ spaced apart in the width direction with a snap groove 313. The snap groove 313 engages with a portion 52 of the bottom cover 50 that defines the corresponding lower embedding space 51, thereby improving the ease of assembly between the lower ends 31b of the upright strips 31 and the bottom cover 50. The handle 40 spans across the light core 10, and the top cover 20 is provided with a first mounting hole 23 for receiving one end 41 of the handle 40 and a second mounting hole 24 for receiving the other end 42 of the handle 40, the second mounting hole 24 being opposite the first mounting hole 23, thereby facilitating assembly of the handle 40 with the top cover 20. Specifically, in FIGS. 3 and 4, as an example, the one end 41 and the other end 42 of the handle 40 are aligned toward each other, and correspondingly, the first mounting hole 23 and the second mounting hole 24 are preferably located on the side wall of the top cover 20. Moreover, because the upper embedding spaces 22 of the top cover 20 extend radially relative to the ring-like structure 30, the lower embedding spaces 51 of the bottom cover 50 also extend radially. The radially extending lower embedding spaces 51 are also adjacent to the peripheral edge 53 of the bottom cover 50, and the lower ends 31b of the upright strips 31 are inserted downward into the lower embedding spaces 51. Preferably, the number of lower embedding spaces 51 may equal or exceed the number of upright strips 31. As shown in FIG. 7, each lower end 31b is further provided with a downwardly extending lower separating slot 314. The two sides 31b′ of the lower end 31b are tapered downward in the width direction. Therefore, the lower separating slot 314 provides resilience to the two sides 31b′ of the lower end 31b. The downwardly tapering configuration facilitates insertion of the lower end 31b into the lower embedding space 51, and the resilience allows the two sides 31b′ to more easily pass over the portion 52 of the bottom cover 50 defining the lower embedding space 51, thereby ensuring smooth engagement of the snap groove 313 with the portion 52. It should be noted that although FIGS. 1 to 4 show the light-emitting product 100a of the first embodiment as including the handle 40 and the bottom cover 50, the product may alternatively be implemented without the handle 40 or the bottom cover 50, and the present disclosure is not limited to the configuration shown in FIGS. 1 to 4.

As shown in FIGS. 3 and 4, in one example, the light core 10 includes an insertion portion 11 having a size smaller than the central through-hole 21 and an outer protruding portion 12 having a size larger than the central through-hole 21. The insertion portion 11 is positioned within the central through-hole 21, and the top cover 20 supports the outer protruding portion 12.

Finally, the assembly process of the light-emitting product 100a of the first embodiment is described: first, insert the upper ends 31a of the upright strips 31 upward into the upper embedding spaces 22 of the top cover 20, ensuring that the engaging grooves 311 engage with the portions 26 defining the upper embedding spaces 22; insert the lower ends 31b of the upright strips 31 downward into the lower embedding spaces 51 of the bottom cover 50, ensuring that the snap grooves 313 engage with the portions 52 defining the lower embedding spaces 51; next, move the light core 10 above the top cover 20 and insert the insertion portion 11 of the light core 10 downward into the central through-hole 21 until the outer protruding portion 12 is supported by the top cover 20; finally, assemble the handle 40 with the top cover 20.

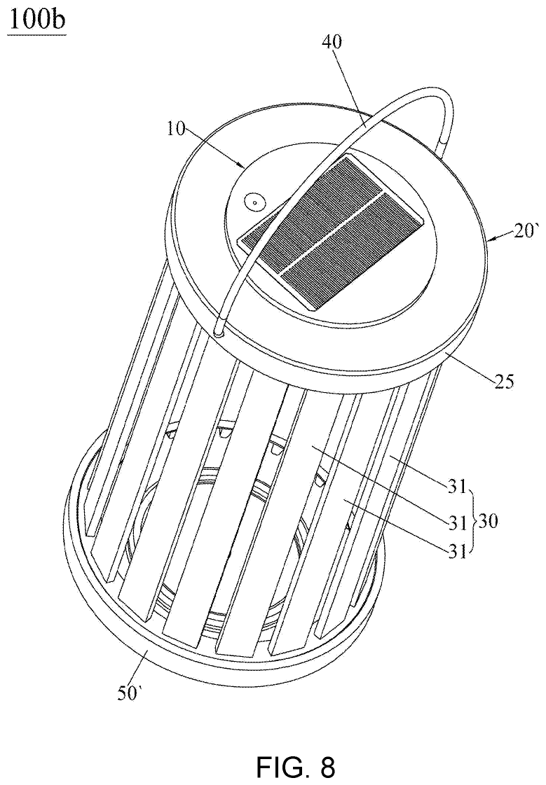

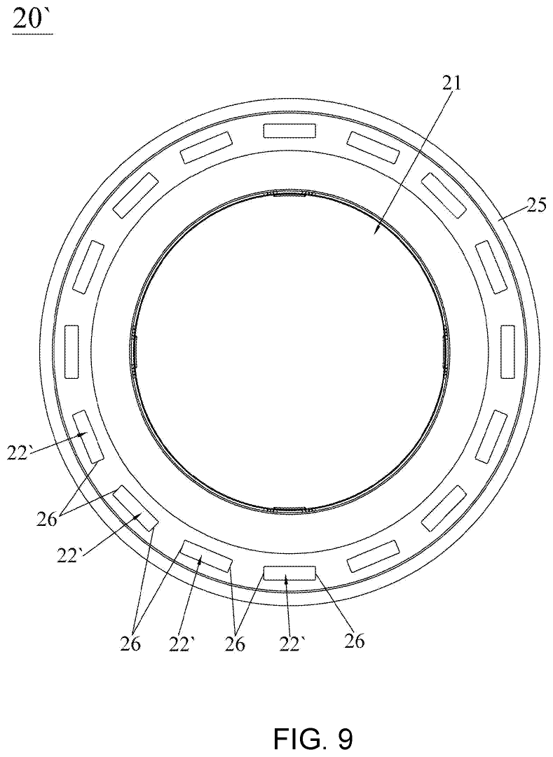

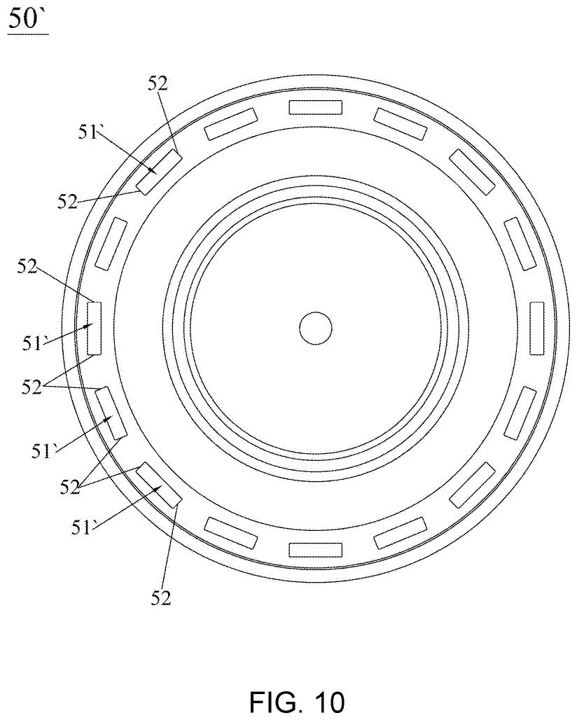

Referring to FIGS. 8 to 10, the structure of the light-emitting product 100b of the second embodiment is substantially the same as that of the light-emitting product 100a of the first embodiment, with the differences described below.

In the light-emitting product 100b of the second embodiment, the upper embedding spaces 22′ extend circumferentially relative to the ring-like structure 30. Correspondingly, the lower embedding spaces 51′ of the bottom cover 50′ and the upright strips 31 fitted therein also extend circumferentially relative to the ring-like structure 30.

In contrast, in the light-emitting product 100a of the first embodiment, the upper embedding spaces 22 extend radially relative to the ring-like structure 30, and correspondingly, the lower embedding spaces 51 of the bottom cover 50 and the upright strips 31 fitted therein also extend radially.

Other than the above differences, the two embodiments are identical, and thus further description is omitted.

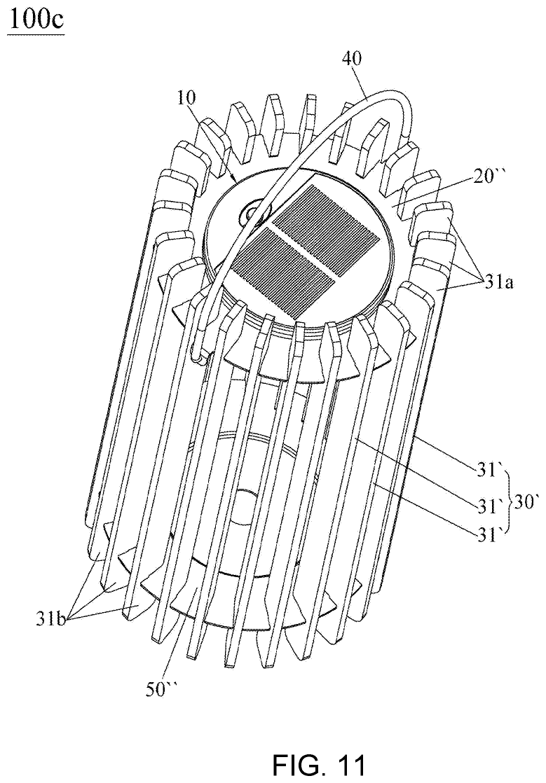

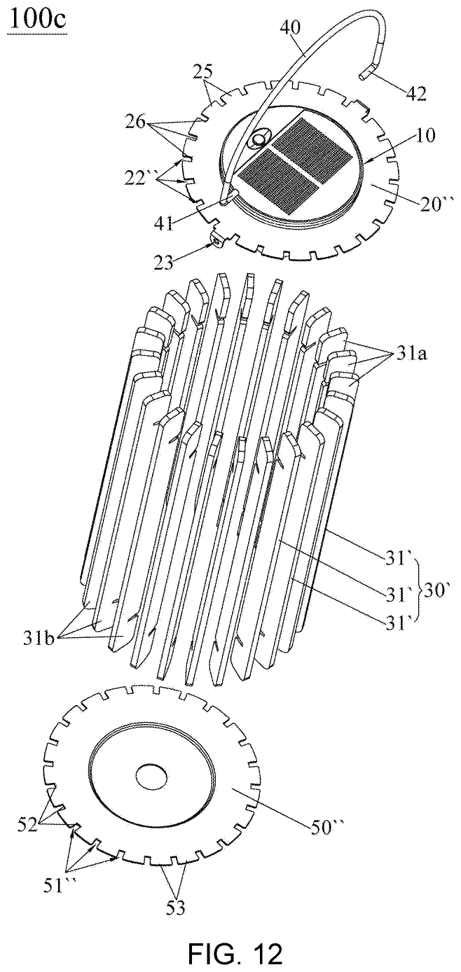

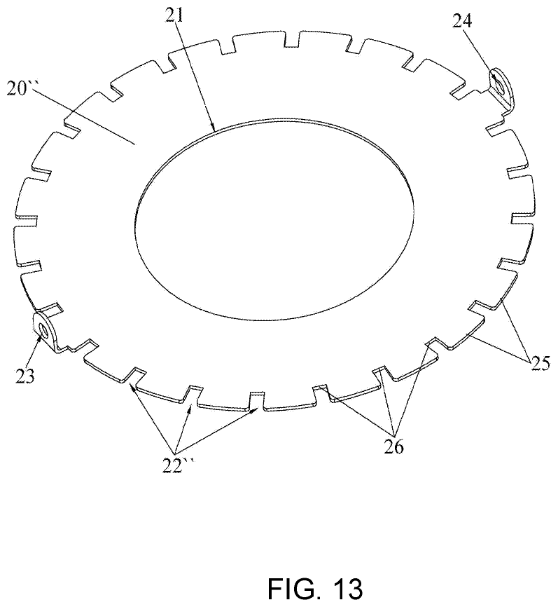

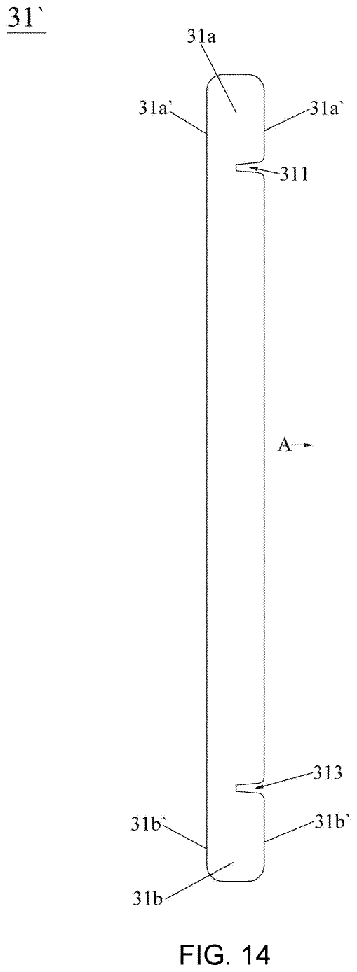

Referring to FIGS. 11 to 14, the structure of the light-emitting product 100c of the third embodiment is substantially the same as that of the light-emitting product 100a of the first embodiment, with the differences described below.

In the light-emitting product 100c of the third embodiment, the upper embedding spaces 22′′ of the top cover 20′′ extend radially outward through the peripheral edge 25 of the top cover 20′′ relative to the ring-like structure 30′. In contrast, in the light-emitting product 100a of the first embodiment, the upper embedding spaces 22 are adjacent to the peripheral edge 25 of the top cover 20.

In the light-emitting product 100c of the third embodiment, the lower embedding spaces 51″ of the bottom cover 50″ extend radially outward through the peripheral edge 53 of the bottom cover 50″ relative to the ring-like structure 30′. In contrast, in the light-emitting product 100a of the first embodiment, the lower embedding spaces 51 are adjacent to the peripheral edge 53 of the bottom cover 50.

In the light-emitting product 100c of the third embodiment, each upright strip 31′ is provided with an engaging groove 311 on only one of the two sides 31a′ of its upper end 31a spaced apart in the width direction, and a snap groove 313 on only one of the two sides 31b′ of its lower end 31b, with the snap groove 313 and the engaging groove 311 being on the same side. In contrast, in the light-emitting product 100a of the first embodiment, each upright strip 31 is provided with engaging grooves 311 on both sides 31a′ of its upper end 31a and snap grooves 313 on both sides 31b′ of its lower end 31b.

In the light-emitting product 100c of the third embodiment, the upright strips 31′ do not have the upper separating slot 312 or the lower separating slot 314 present in the first embodiment.

In the light-emitting product 100c of the third embodiment, the upright strips 31′ do not have the features where “the two sides 31a′ of the upper end 31a taper upward” and “the two sides 31b′ of the lower end 31b taper downward” as present in the first embodiment.

Other than the above differences, the two embodiments are identical, and thus further description is omitted.

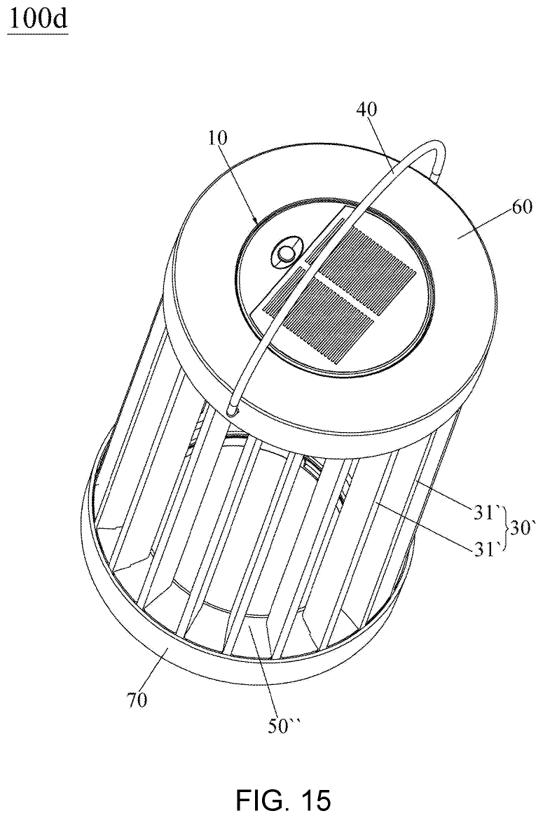

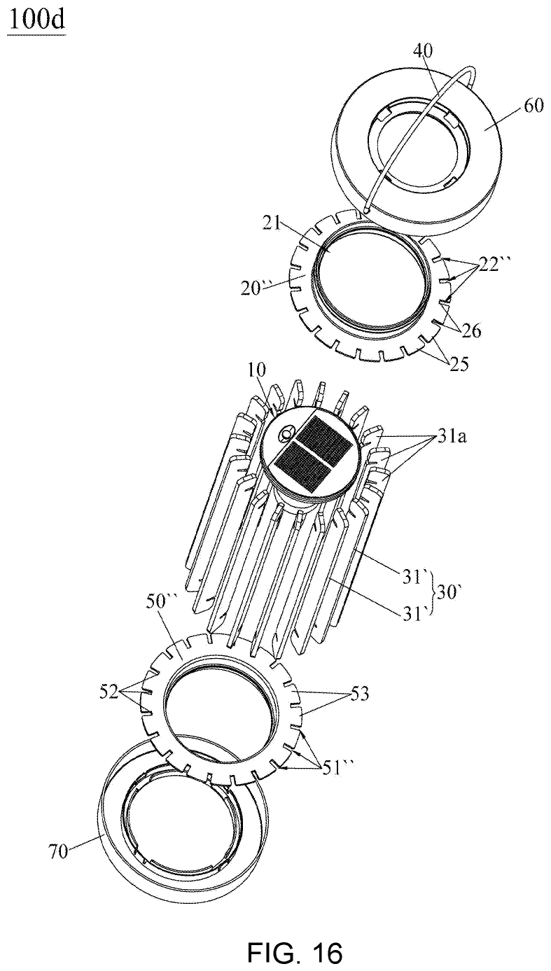

Referring to FIGS. 15 to 16, the structure of the light-emitting product 100d of the fourth embodiment is substantially the same as that of the light-emitting product 100c of the third embodiment, with the differences described below.

In the light-emitting product 100d of the fourth embodiment, a top cover outer casing 60 is mounted on the top cover 20″ and surrounds all of the upper ends 31a of the upright strips 31′ from the outside. The top cover outer casing 60 applies an external force to the upper ends 31a of all of the upright strips 31′, while the top cover 20″ applies an internal force, thereby clamping the upper ends 31a between the top cover 20″ and the top cover outer casing 60, further improving the stability of the assembly connection. In contrast, the light-emitting product 100c of the third embodiment does not have the top cover outer casing 60.

In the light-emitting product 100d of the fourth embodiment, a bottom cover outer casing 70 is mounted on the bottom cover 50″ and surrounds all of the lower ends 31b of the upright strips 31′ from the outside. The bottom cover outer casing 70 applies an external force to the lower ends 31b of all of the upright strips 31′, while the bottom cover 50″ applies an internal force, thereby clamping the lower ends 31b between the bottom cover 50″ and the bottom cover outer casing 70, further improving the stability of the assembly connection. In contrast, the light-emitting product 100c of the third embodiment does not have the bottom cover outer casing 70.

In the light-emitting product 100d of the fourth embodiment, when the top cover outer casing 60 is provided, the first and second mounting holes for the handle 40 are provided on the top cover outer casing 60, so that the handle 40 is indirectly assembled with the top cover 20″ via the top cover outer casing 60.

Other than the above differences, the two embodiments are identical, and thus further description is omitted.

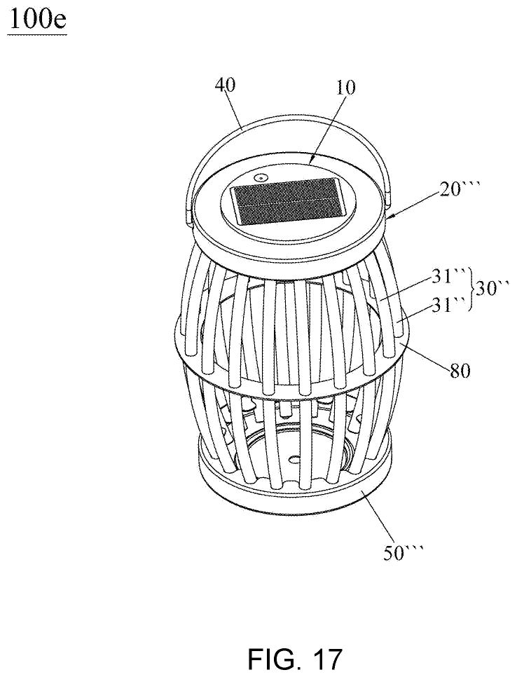

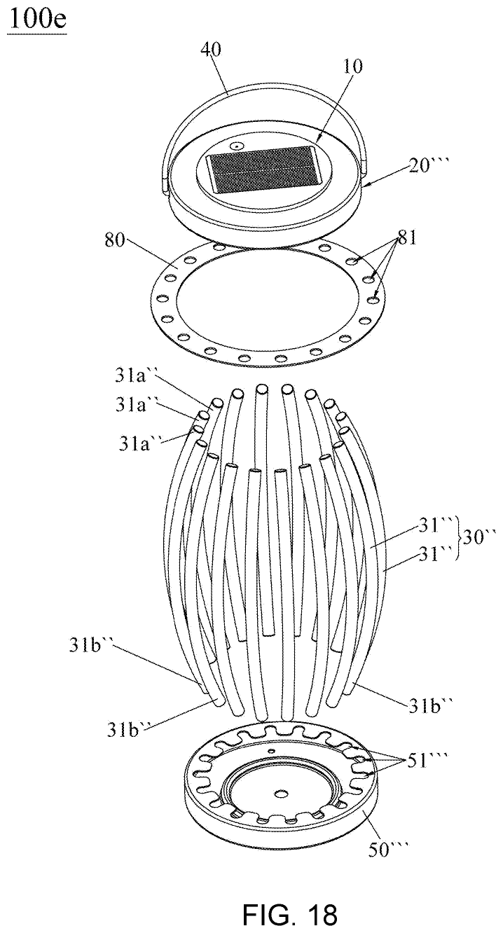

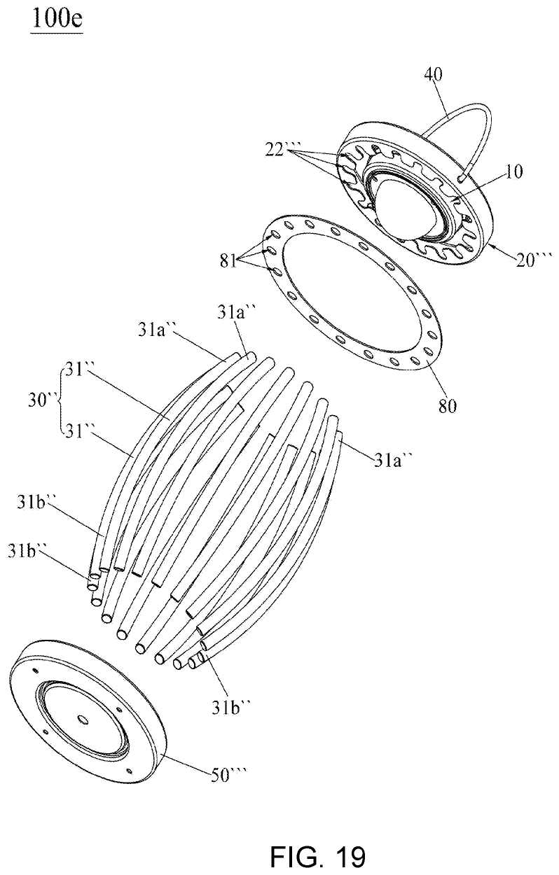

Referring to FIGS. 17 to 19, the differences between the light-emitting product 100e of the fifth embodiment and the light-emitting product 100a of the first embodiment are described below.

In the light-emitting product 100e of the fifth embodiment, the inner ends of the upper embedding spaces 22″′ and the lower embedding spaces 51′″ are open ends, so that the upper ends 31a″ of the upright strips 31″ can be installed from the inside out into the upper embedding spaces 22′″, and the lower ends 31b″ of the upright strips 31″ can be installed from the inside out into the lower embedding spaces 51′″. In contrast, in the light-emitting product 100a of the first embodiment, both ends of the upper embedding spaces 22 and the lower embedding spaces 51 in the radial direction of the ring-like structure 30 are closed ends, so that the upper ends 31a of the upright strips 31 are inserted upward into the upper embedding spaces 22, and the lower ends 31b are inserted downward into the lower embedding spaces 51.

In the light-emitting product 100e of the fifth embodiment, an intermediate positioning seat 80 is provided between the top cover 20′″ and the bottom cover 50′″. The intermediate positioning seat 80 is provided with a plurality of through positioning holes 81 arranged in a ring-like pattern, and each upright strip 31″ is inserted through a corresponding through positioning hole 81. The intermediate positioning seat 80, together with the top cover 20′″ and the bottom cover 50′″, stabilizes all of the upright strips 31″. In contrast, in the light-emitting product 100a of the first embodiment, the upper ends 31a of the upright strips 31 are engaged with the top cover 20 via the engaging grooves 311, and the lower ends 31b are engaged with the bottom cover 50 via the snap grooves 313. Moreover, the upper ends 31a are provided with upwardly extending upper separating slots 312 and taper upward, while the lower ends 31b are provided with downwardly extending lower separating slots 314 and taper downward.

In the light-emitting product 100e of the fifth embodiment, each upright strip 31″ is a post that arches outward in the middle relative to its upper end 31a″ and lower end 31b″. In contrast, in the light-emitting product 100a of the first embodiment, the upright strips 31 are straight strip-like sheet structures.

Other than the above differences, the two embodiments are identical, and thus further description is omitted.

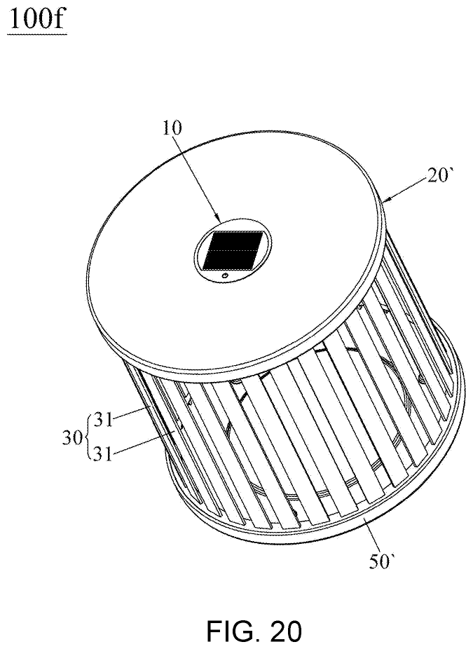

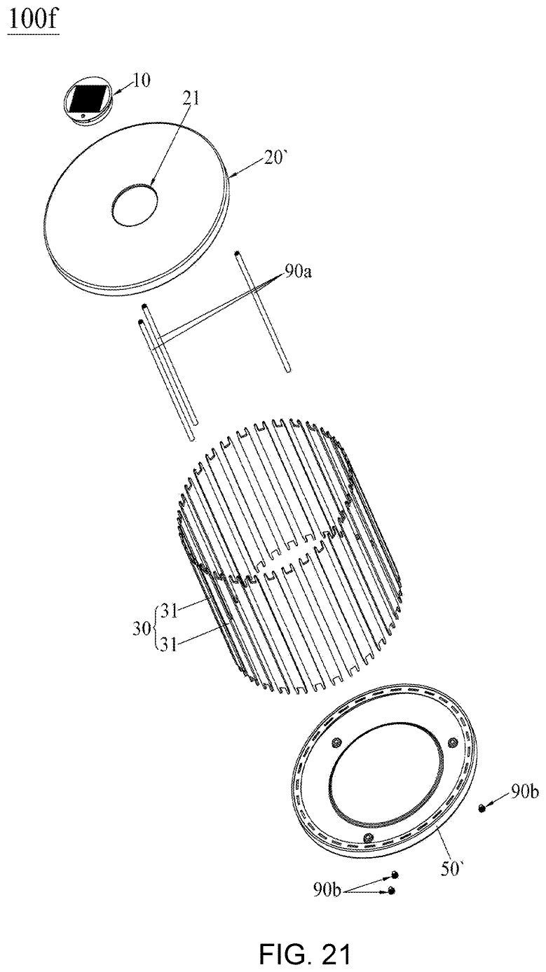

Referring to FIGS. 20 and 21, the differences between the light-emitting product 100f of the sixth embodiment and the light-emitting product 100b of the second embodiment are described below.

In the light-emitting product 100f of the sixth embodiment, the product 100f is overall larger than the product 100b of the second embodiment. The product 100f further includes a connecting screw rod 90a and a screw 90b threadedly connected to the connecting screw rod 90a, the connecting screw rod 90a and the screw 90b being arranged one above the other. The top cover 20′ is threadedly connected to the connecting screw rod 90a. The connecting screw rod 90a passes through the bottom cover 50′ and is threadedly connected to the screw 90b. The connecting screw rod 90a is located inside the ring-like structure 30 to ensure sufficient connection strength for the product 100f. In one option, the number of connecting screw rods 90a and screws 90b is three each. In contrast, the light-emitting product 100b of the second embodiment does not include the connecting screw rod 90a or the screw 90b.

The light-emitting product 100f of the sixth embodiment does not include the handle 40, whereas the light-emitting product 100b of the second embodiment does include the handle 40.

Other than the above differences, the two embodiments are identical, and thus further description is omitted.

Compared to the prior art, the top cover 20 (20′, 20″, 20′″) is provided with the central through-hole 21 and the plurality of upper embedding spaces 22 (22′, 22″, 22′″) spaced apart and arranged around the central through-hole 21, the upper ends 31a (31a″) of the upright strips 31 (31′, 31″) are fitted into the upper embedding spaces 22 (22′, 22″, 22′″), the light core 10 is inserted into the central through-hole 21, and the top cover 20 (20′, 20″, 20′″) supports the light core 10 from below. Therefore, this configuration, on one hand, allows users to easily assemble the light-emitting product 100a (100b, 100c, 100d, 100e, 100f) by hand without any tools, and on the other hand, because the light-emitting product can be packaged in a disassembled state, it offers the advantages of convenient storage and transport.

It is additionally noted that the light-emitting product 100a shown in FIG. 1, the light-emitting product 100b shown in FIG. 8, the light-emitting product 100c shown in FIG. 11, the light-emitting product 100d shown in FIG. 15, and the light-emitting product 100f shown in FIG. 20 are all illuminated columnar products; while the light-emitting product 100e shown in FIG. 17 is an illuminated drum-shaped product. Specifically, the light-emitting product 100a shown in FIG. 1, the light-emitting product 100b shown in FIG. 8, the light-emitting product 100c shown in FIG. 11, the light-emitting product 100d shown in FIG. 15, and the light-emitting product 100e shown in FIG. 17 are lighting fixtures, such as, but not limited to, table lamps, portable lamps, or pendant lamps. The light-emitting product 100f shown in FIG. 20 is an illuminated side table. Thus, the light-emitting product 100a (100b, 100c, 100d, 100e, 100f) of the present disclosure can be an illuminated lighting fixture or side table, among other possibilities.

The above disclosure is merely of preferred embodiments of the present disclosure and is not intended to limit the scope of the present disclosure. Accordingly, any equivalent changes made in light of the claims of the present disclosure shall fall within the scope of the present disclosure.

What is claimed is:

1. A light-emitting product, comprising:
a light core,
a top cover, and
a plurality of upright strips spaced apart from each other and collectively arranged to form a ring-like structure;
wherein the top cover is provided with a central through-hole and a plurality of upper embedding spaces spaced apart from each other and arranged around the central through-hole;
upper ends of the upright strips are fitted into the upper embedding spaces; and
the light core is inserted through the central through-hole, and the top cover further supports the light core from below.

2. The light-emitting product according to claim 1, wherein the light core has an insertion portion with a size smaller than the central through-hole, and an outer protruding portion with a size larger than the central through-hole; the insertion portion is located in the central through-hole;
and the top cover supports the outer protruding portion.

3. The light-emitting product according to claim 1, wherein the upper ends of the upright strips are each provided, on at least one of two sides thereof spaced apart in a width direction, with an engaging groove, and the engaging groove engages with a portion of the top cover that defines a corresponding one of the upper embedding spaces.

4. The light-emitting product according to claim 3, wherein the upper embedding spaces are adjacent to a peripheral edge of the top cover, and the upper ends of the upright strips are fitted upward into the upper embedding spaces.

5. The light-emitting product according to claim 3, wherein the upper embedding spaces extend radially through a peripheral edge of the top cover, and a top cover outer casing is mounted on the top cover and surrounds the upper ends of all of the upright strips from outside.

6. The light-emitting product according to claim 4, further comprising a handle spanning across the light core, wherein the top cover or the top cover outer casing is provided with a first mounting hole for receiving one end of the handle and a second mounting hole for receiving the other end of the handle, the second mounting hole being opposite the first mounting hole.

7. The light-emitting product according to claim 5, further comprising a handle spanning across the light core, wherein the top cover outer casing is provided with a first mounting hole for receiving one end of the handle and a second mounting hole for receiving the other end of the handle, the second mounting hole being opposite the first mounting hole.

8. The light-emitting product according to claim 3, wherein the upper embedding spaces are adjacent to a peripheral edge of the top cover, and the upper ends of the upright strips are fitted upward into the upper embedding spaces; and
wherein the upper ends of the upright strips are each further provided with an upwardly extending upper separating slot, and the two sides of the upper ends spaced apart in the width direction are tapered upward.

9. The light-emitting product according to claim 1, further comprising a bottom cover, wherein the bottom cover is provided with a plurality of lower embedding spaces spaced apart from each other and arranged in a ring-like configuration, and lower ends of the upright strips are fitted into the lower embedding spaces.

10. The light-emitting product according to claim 9, wherein the upper embedding spaces and the lower embedding spaces each extend in a circumferential direction of the ring-like structure, or each extend in a radial direction of the ring-like structure; and
wherein the lower ends of the upright strips are each provided, on at least one of two sides thereof spaced apart in the width direction, with a snap groove, and the snap groove engages with a portion of the bottom cover that defines a corresponding one of the lower embedding spaces.

11. The light-emitting product according to claim 9, wherein the lower embedding spaces are adjacent to a peripheral edge of the bottom cover, and the lower ends of the upright strips are fitted downward into the lower embedding spaces; and
wherein the lower ends of the upright strips are each further provided with a downwardly extending lower separating slot, and the two sides of the lower ends spaced apart in the width direction are tapered downward.

12. The light-emitting product according to claim 9, wherein the light-emitting product further comprises a connecting screw rod and a screw threadedly connected to the connecting screw rod, the connecting screw rod and the screw being arranged one above the other, one of the top cover and the bottom cover is threadedly connected to the connecting screw rod, the connecting screw rod passes through the other of the top cover and the bottom cover and is threadedly connected to the screw, and the connecting screw rod is located inside the ring-like structure.

13. The light-emitting product according to claim 9, wherein the lower embedding spaces extend radially outward through a peripheral edge of the bottom cover, and a bottom cover outer casing is mounted on the bottom cover and surrounds the lower ends of all of the upright strips from outside.

14. The light-emitting product according to claim 9, wherein the upper embedding spaces and the lower embedding spaces each extend in a radial direction of the ring-like structure and have inner ends that are open ends, and an intermediate positioning seat is provided between the top cover and the bottom cover, the intermediate positioning seat having a plurality of through positioning holes arranged in a ring-like configuration, and each of the upright strips is inserted through a corresponding one of the through positioning holes.
